(19) United States
(12) Patent Application Publication
(10) Pub. No.: US 2008/0006331 A1
(43) Pub. Date: Jan. 10, 2008

(54) Differential pressure valve

(75) Inventors: Toshiyuki Shiota, Tokyo (JP); Yoichi Miura, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TGK Co., Ltd., Tokyo (JP)

(21) Appl. No.: 11/808,969

(22) Filed: Jun. 14, 2007

(30) Foreign Application Priority Data
Jun. 16, 2006 (JP) 2006-167141

(51) Int. Cl. F16K 21/10

(52) U.S. Cl. 137/514.5

(57) ABSTRACT

To provide a differential pressure valve which is capable of suppressing generation of noise when a variable displacement compressor is being operated at its minimum displacement. A hollow cylindrical protruding portion of a valve element, which is disposed in a manner surrounding a hollow cylindrical valve seat, is configured to have two windows formed at circumferentially one-sided locations as openings of a sleeve valve. As a result, the difference is generated between areas of regions of an inner peripheral surface of the hollow cylindrical protruding portion circumferentially separated by the windows, to thereby make transverse load unbalanced, so that the valve element performs opening and closing operations always in a state in which the hollow cylindrical protruding portion is transversely pressed against the hollow cylindrical valve seat. This makes it possible to suppress generation of noise due to striking of the valve seat by the valve element when it moves transversely unsteadily or wobbles in an inclined state during the opening and closing operations of the differential pressure valve.

### CROSS-REFERENCE TO RELATED APPLICATION, IF ANY

This application claims priority of Japanese Application No. 2006-167141 filed on Jun. 16, 2006 and entitled “Differential Pressure Valve”.

### BACKGROUND OF THE INVENTION

(1) Field of the Invention

The present invention relates to a differential pressure valve, and more particularly to a differential pressure valve which can be suitably applied to a clutchless type variable displacement compressor used in an automotive air conditioner, which is directly connected to an automotive engine for being driven thereby.

(2) Description of the Related Art

An automotive air conditioner is equipped with a compressor for compressing refrigerant, which uses an automotive engine as a drive source. The compressor is largely varied in the rotational speed of the engine depending on a traveling condition of a vehicle, and hence a variable displacement compressor is employed which is capable of varying refrigerant displacement such that the refrigerant displacement can be held at a set displacement irrespective of the rotational speed of the engine. The variable displacement compressor is connected to the automotive engine via an electromagnetic clutch, and when the automotive air conditioner is not in use, the clutch is disengaged so as to inhibit the driving force of the engine from being transmitted to the variable displacement compressor, whereas during the operation of the air conditioner, the clutch is engaged so as to drive the variable displacement compressor by the engine.

In general, when a vehicle is provided with an electromagnetic clutch, the weight of the vehicle increases and the manufacturing cost of the vehicle is increased. Further, when the clutch is in operation, large electric power is consumed. As a solution to these problems, a so-called clutchless type variable displacement compressor is known which is configured such that no electromagnetic clutch is installed thereon and the compressor is directly connected to the vehicular engine. The clutchless type variable displacement compressor is always driven for rotation when the engine is rotating, and hence particularly when the automotive air conditioner is not started, it is necessary that the compressor is controlled to a state where the displacement thereof becomes minimum.

However, although the variable displacement compressor is controlled to the operating state of the minimum displacement, the displacement thereof is not zero. Therefore, the variable displacement compressor continues to discharge the amount of refrigerant corresponding to the minimum displacement to continuously circulate the refrigerant through the refrigeration cycle. During stoppage of the automotive air conditioner, since a blower, which blows air from the vehicle compartment toward the evaporator for heat exchange, is not in operation, the heat exchange is not performed in the evaporator. For this reason, even if cooled refrigerant is delivered from an expansion valve to the evaporator, the refrigerant remains in the evaporator without being evaporated, or the outer periphery of the evaporator has frost attached thereto to be frosted. Further, although refrigerator oil is contained in the refrigerant so as to be circulated through the refrigeration cycle, when in the operating state of the minimum displacement, the refrigerator oil discharged from the compressor remains in the condenser, the evaporator, etc., without being returned to the compressor, which sometimes causes seizure of the compressor.

To solve the above problems, in the clutchless type variable displacement compressor, a differential pressure valve having a check valve structure is provided in a passage into which refrigerant is discharged from the discharge chamber. In general, a check valve is configured such that a valve element is disposed on a downstream side of a valve seat with respect to the flow of refrigerant, and the valve element is urged by a spring in the valve-closing direction, and therefore as the spring acting on the valve element in the valve-closing direction, there is employed one having a weak spring load so as to minimize pressure loss with respect to the flow of refrigerant in the valve-opening direction. In contrast, a differential pressure valve used in the variable displacement compressor uses a spring having a spring force stronger than that of the spring used in the check valve, and is configured such that the differential pressure valve closes when discharge pressure is low as when the automotive air conditioner is not in operation, and opens for discharging refrigerant when the discharge pressure becomes equal to or higher than a certain degree of pressure.

In such a differential pressure valve, when the variable displacement compressor is being operated at its minimum displacement, the compressor is performing compression at the minimum displacement in a state in which the outlet port of the discharge chamber is closed by the differential pressure valve, so that pressure in the discharge chamber becomes progressively higher. When load acting on the valve element of the differential pressure valve by the discharge pressure in the valve-opening direction exceeds the load of the spring acting in the valve-closing direction, the differential pressure valve starts to open. When the differential pressure valve opens, refrigerant is allowed to flow downstream from the differential pressure valve to lower the pressure in the discharge chamber, so that the valve element is pressed by the load of the spring, and the differential pressure valve starts to be closed.

As described hereinabove, when the variable displacement compressor is operating at the minimum displacement, there occurs a hunting phenomenon that the differential pressure valve repeatedly opens to a very small opening degree and closes. The hunting phenomenon is one in which the differential pressure largely increases and decreases without almost any change in the flow rate of refrigerant. If the hunting phenomenon occurs, the valve element strikes the valve seat, and vibration noise and other noises are caused by the striking noise.

A differential pressure valve configured to suppress the hunting phenomenon has already been proposed (see e.g. Japanese Unexamined Patent Publication No. 2000-346217 (Paragraph Nos. [0019] to [0046])). In the differential pressure valve, flow rate control is realized in a manner such that when the differential pressure valve starts to open, the opening area of a passage through which refrigerant is discharged from the discharge chamber is reduced, and as the amount of lift of the valve element caused by the urging force of the discharge pressure increases, the opening area of the passage is increased. Thus, the opening area of the passage is reduced when the differential pressure valve starts opening and completes closing, thereby preventing the pressure in the discharge chamber from being sharply reduced, so that occurrence of the hunting phenomenon is suppressed.

Now, the differential pressure valve to which the present invention is directed is different in structure from the differential pressure valve proposed in Japanese Unexamined Patent Publication No. 2000-346217, and hence a description will be given of a conventional differential pressure valve to which the present invention is directed.

FIG. 5 is a perspective view showing the shape of a valve element of the conventional differential pressure valve. The valve element 100 has three openings 100a to 100c formed in the circumference of the valve element 100 as cutouts, and the shape of the openings 100a to 100c varies such that it becomes larger toward the foremost end of the valve element. Therefore, by combining the valve element 100 and a hollow cylindrical valve seat, it is possible to realize the same flow rate control as that realized by the differential pressure valve proposed in Japanese Unexamined Patent Publication No. 2000-346217.

FIG. 6 shows a differential pressure valve in a closed state in which the valve element 100 is disposed in the body and is pressed by a coil spring 102 against a seat face 103a of the hollow cylindrical valve seat 103 integrally formed with a housing 101. In this differential pressure valve, refrigerant compressed by a variable displacement compressor, not shown, is introduced through an inlet port 104 open upward. The coil spring 102 is disposed such that it urges the valve element 100 toward the seat face 103a of the valve seat 103. The valve element 100 has a hollow cylindrical protruding portion 106 formed around a sealing surface 105 which is seated on the seat face 103a. By forming the hollow cylindrical protruding portion 106 on the valve element 100, when the valve element 100 axially moves, the outer peripheral surface 103b of the valve seat 103 functions as a guide surface. When the pressure of the compressed refrigerant becomes higher in the inlet port 104 to make the differential pressure between the pressure on the inlet port side and pressure on the outlet port side becomes larger than the spring load of the coil spring 102, the valve element 100 starts to move downward, as viewed in FIG. 6.

FIG. 7 is a plan view showing the positional relationship between three openings of the valve element. As shown in this figure, the openings 100a to 100c of the valve element are circumferentially formed in the hollow cylindrical protruding portion 106 such that they have the same size and are arranged at equal spaced intervals of 120°. When the valve element 100 axially moves forward and backward, the three openings 100a to 100c open such that opening areas thereof are progressively increased equally and continuously. Therefore, when the valve starts opening and completes closing, the area of a passage formed by the openings 100a to 100c is small, and hence pressure acting on the valve element 100 is not sharply reduced, which suppresses occurrence of the hunting phenomenon.

Moreover, three protrusions 106a to 106c forming the hollow cylindrical protruding portion 106 are arranged uniformly at equal spaced intervals of 120°, so that load corresponding to the pressure of the refrigerant acts on the valve element 100 in the axial direction thereof, but uniform pressure is axially and radially applied to the valve element 100 in a balanced state. This allows the valve element 100 to smoothly operate in the opening or closing direction of the valve element 100.

However, the axial and radial pressure on the valve element 100 uniformly acts at spaced intervals of 120°, in a balanced state, and hence when the valve element 100 is slightly open, the valve element 100 can sometimes unsteadily move due to some cause, to abut against the outer peripheral surface 103b of the hollow cylindrical valve seat 103, which makes it impossible to completely eliminate noise caused by the opening and closing of the valve element.

Further, the coil spring 102 does not necessarily urge the valve element 100 uniformly toward the seat face 103a of the valve seat 103 due to its structure. Therefore, the sealing surface 105 of the valve element 100 is obliquely urged, as shown in FIG. 8, and when the valve element 100 is very slightly open, the opening areas of the openings 100a to 100c do not become uniform, whereby the valve element 100 wobbles to repeatedly strike the valve seat 103, which results in further increased noise.

### SUMMARY OF THE INVENTION

The present invention has been made in view of the above problems, and an object thereof is to provide a differential pressure valve which is capable of suppressing generation of noise when a variable displacement compressor is being operated at its minimum displacement.

To solve the above problems, the present invention provides a differential pressure valve disposed in a passage communicating with a discharge chamber of a variable displacement compressor, for opening when a difference in pressure between an inlet and an outlet thereof exceeds predetermined pressure, comprising an inlet port into which refrigerant from the discharge chamber is introduced, a hollow cylindrical valve seat extending from a periphery of the inlet port toward a downstream side, a valve element having a sealing surface moving to and away from an end face of the valve seat, a hollow cylindrical protruding portion extending from an outer periphery of the sealing surface in a manner surrounding the valve seat, and an opening formed through the hollow cylindrical protruding portion, and a spring for urging the valve element in a valve-closing direction, the differential pressure valve further comprising load-generating means for generating load for pressing the hollow cylindrical protruding portion of the valve element against an outer peripheral surface of the valve seat.

The above and other objects, features and advantages of the present invention will becomes apparent from the following description when taken in conjunction with the accompanying drawings which illustrate preferred embodiments of the present invention by way of example.

### BRIEF DESCRIPTION OF THE DRAWINGS

FIG. 1 is a cross-sectional view showing the construction of a differential pressure valve in a closed state according to the present invention.

FIG. 2 is a perspective view showing the shape of a valve element of the differential pressure valve according to the present invention

FIG. 3 is a plan view showing the arrangement of openings of the differential pressure valve according to the present invention

FIG. 4 is a diagram useful in explaining a state in which load transverse to the valve element is generated.

FIG. 5 is a perspective view showing the shape of a valve element of a conventional differential pressure valve.

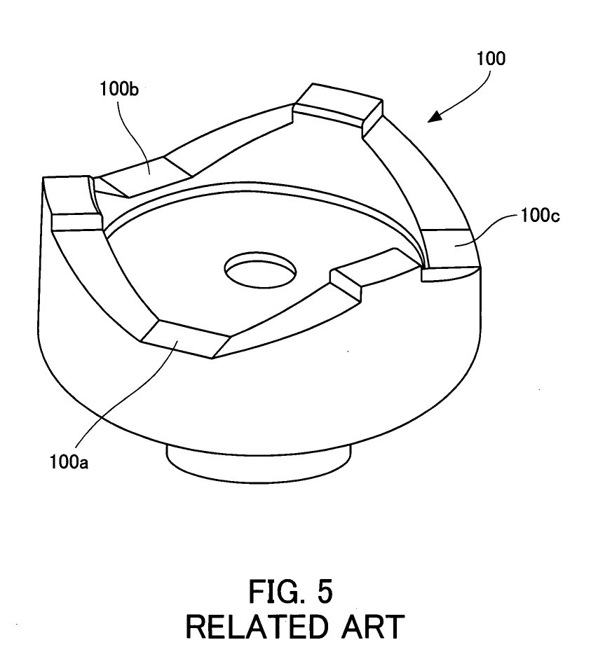

FIG. 6 is a cross-sectional view showing the construction of the conventional differential pressure valve in a closed state.

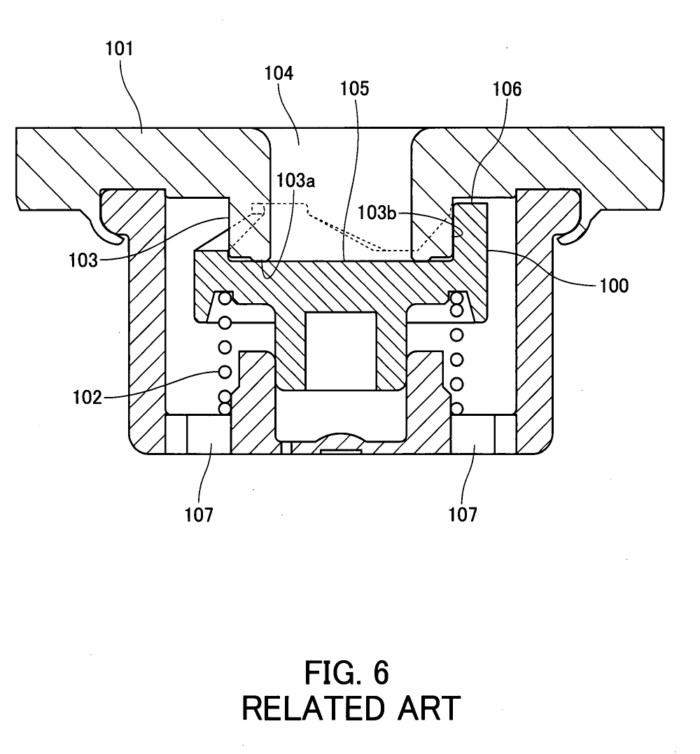

FIG. 7 is a plan view showing the valve element of the conventional differential pressure valve, which is useful in explaining the positional relationship between three openings of the valve element.

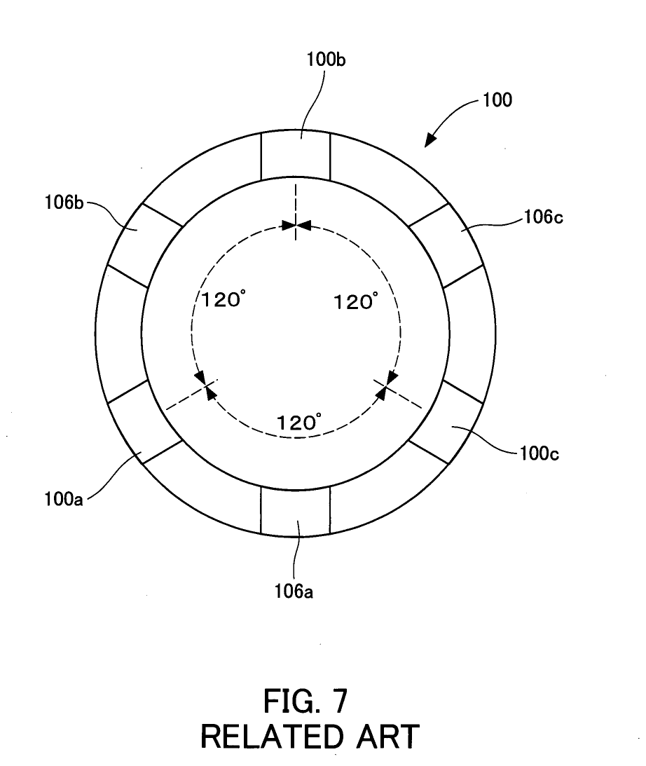

FIG. 8 is a diagram which is useful in explaining pressure acting on the valve element of the conventional differential pressure valve.

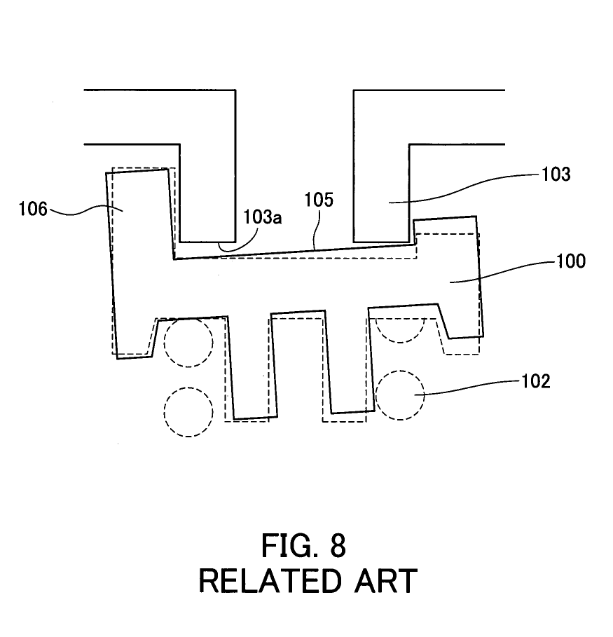

### DESCRIPTION OF THE PREFERRED EMBODIMENTS

Hereinafter, an embodiment of a differential pressure valve according to the present invention will be described in detail based on an example in which it is applied to a clutchless type variable displacement compressor.

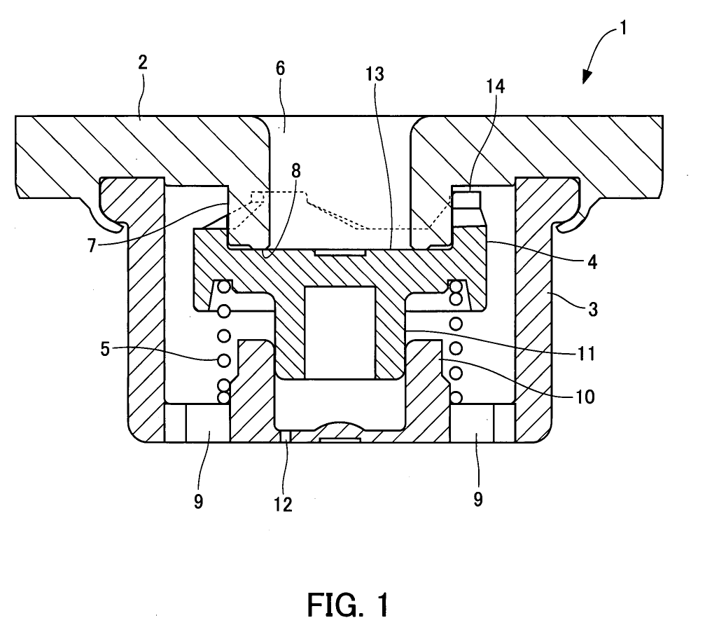

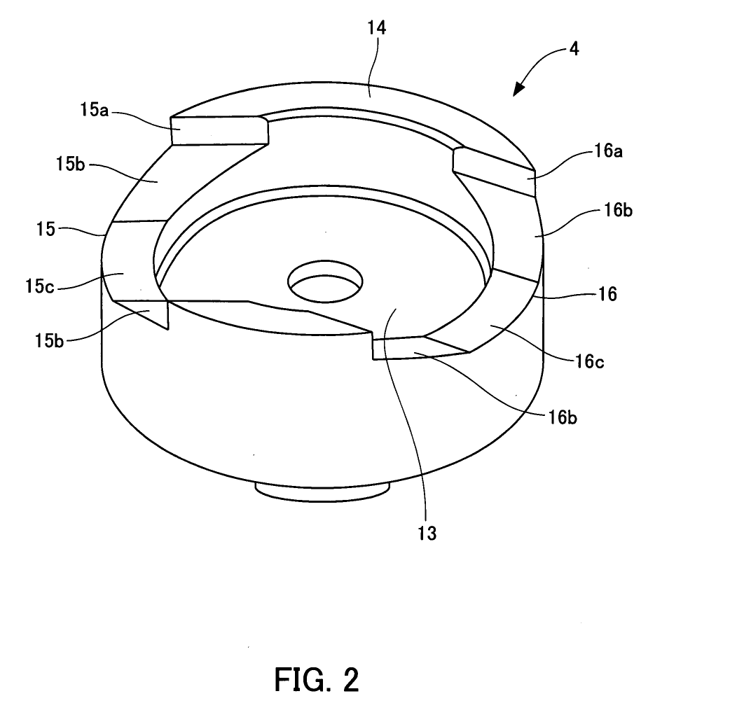

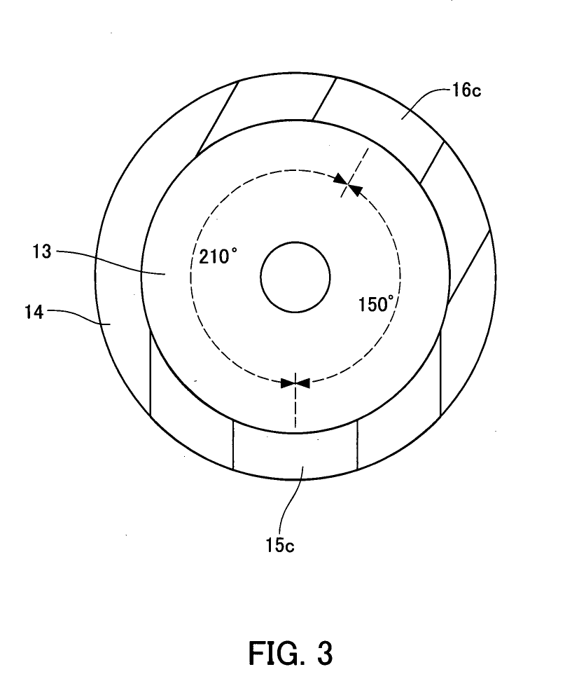

FIG. 1 is a cross-sectional view showing the construction of the differential pressure valve in a closed state according to the present invention. FIG. 2 is a perspective view showing the shape of a valve element of the differential pressure valve according to the present invention. FIG. 3 is a plan view showing the arrangement of openings of the differential pressure valve according to the present invention.

The differential pressure valve 1 according to the present invention comprises a housing 2, a body 3, a valve element 4, and a coil spring 5. The housing 2, which is made of brass, is fitted into a passage leading to a discharge chamber of the compressor, and has an inlet port 6 in a central portion thereof. The inlet port 6 has a periphery integrally formed with a hollow cylindrical valve seat 7 extending perpendicularly downward therefrom. The valve seat 7 has a seat face 8 formed at a foremost end thereof opposed to the valve element 4. The body 3, which is made e.g. of a resin, is connected to the housing 2 by swaging, and has a plurality of outlet ports 9 formed through a bottom surface thereof in a manner arranged along the circumference thereof. Further, the body 3 has a hollow cylindrical portion 10 integrally formed therewith on a central portion of the bottom surface thereof in a manner directed upward. The hollow cylindrical portion 10 axially movably holds a hollow cylindrical extending portion 11 extending from the valve element 4 in an axial direction thereof. The hollow cylindrical portion 10 of the body 3 and the hollow cylindrical extending portion 11 of the valve element 4 form a damper chamber such that the valve element 4 is prevented from being vibrated in the axial direction thereof. It should be noted that an oil drain hole 12 is formed in the body 3 so as to prevent refrigerator oil contained in refrigerant from being collected in the damper chamber.

The valve element 4 has a hollow cylindrical protruding portion 14 integrally formed therewith outside a sealing surface 13 which is seated on the seat face 8, in a manner protruding therefrom to have a hollow cylindrical shape such that it surrounds an outer periphery of the valve seat 7. The hollow cylindrical protruding portion 14 is capable of causing the valve element 4 to axially move forward and backward, using the outer periphery of the valve seat 7 as a guide surface.

The coil spring 5 is fitted on the hollow cylindrical portion 10 of the body 3, and has an upper end thereof brought into contact with a rear surface of the valve element 4 such that the coil spring 5 urges the valve element 4 in the valve-closing direction.

Thus, the valve element 4 is provided within the body 3 in an axially movable state, and is urged toward the seat face 8 of the valve seat 7 by the coil spring 5. Therefore, even if refrigerant compressed by the compressor is introduced into the inlet port 6, so long as the pressure of the refrigerant is within a range of the spring load of the coil spring, the valve element 4 remains seated on an end face of the inlet port 6 serving as the seat face 8, whereby the refrigerant is not delivered to the outlet ports 9.

Next, a detailed description will be given of the valve element 4, by which is characterized the differential pressure valve according to the present invention. As shown in FIG. 2, the hollow cylindrical protruding portion 14 of the valve element 4 is formed with two windows 15 and 16 as openings having the same size. Portions of the hollow cylindrical protruding portion 14, which are not formed with the windows 15 and 16, are configured to have a height generally corresponding to the length of the valve seat 7 of the body 3. The windows 15 and 16 comprise side surfaces 15a and 16a cut in the axial direction of the valve element 4, inclined surfaces 15b and 16b inclined at a predetermined angle with respect to the sealing surface 13, and bottom surfaces 15c and 16c parallel to the sealing surface 13, respectively, and are configured such that the areas of the openings in the axial direction progressively vary along the inclined surfaces 15b and 16b.

Further, as shown in FIG. 3, the windows 15 and 16 are arranged in a manner one-sided about the axis of the valve element 4. In the present embodiment, the windows 15 and 16 are arranged such that the centers of the bottom surfaces 15c and 16c are separated from each other by 150° about the axis of the valve element 4.

Therefore, the areas of the openings of the windows 15 and 16 communicating with the outlet ports 9 continuously increase with the lift amount of the valve element 4. More specifically, when the valve element 4 starts to be opened by the pressure of refrigerant compressed by the compressor, after the sealing surface 13 of the valve element 4 moves away from the seat face 8 of the valve seat 7, the area of the opening of the refrigerant passage progressively increases, whereas when the valve element 4 completely closes, the area progressively decreases. Moreover, after the valve element 4 starts to open and until the valve element 4 completely closes, the areas of inner wall surfaces of the hollow cylindrical protruding portion 14 of the valve element 4, which receive the refrigerant pressure introduced into the inlet port 6, are different due to difference spaced intervals (of 150° and 210°) between the window 15 and the window 16. As a result, load applied to the whole periphery transversely to the axial direction of the valve element 4 is not uniform, but one-sided load acts on the valve element 4.

Next, a description will be given of pressure acting on the valve element.

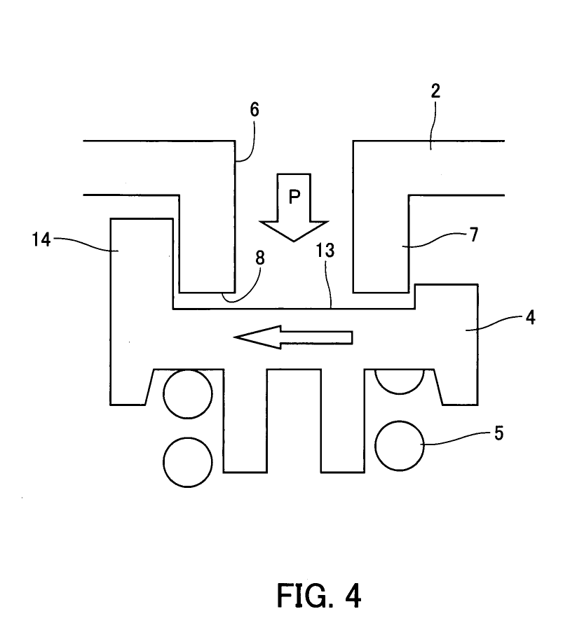

FIG. 4 is a diagram useful in explaining a state in which load transverse to the valve element is generated.

First, when pressure across the differential pressure valve 1 is sufficiently small, and hence the sealing surface 13 of the valve element 4 is seated on the seat face 8 of the valve seat 7 to close the differential pressure valve 1, the pressure P of refrigerant introduced into the inlet port 6 acts on the sealing surface 13 of the valve element 4 in a direction perpendicular thereto.

When the pressure P increases to cause the differential pressure between pressure in the inlet port 6 and pressure in the outlet port 9 to exceed a predetermined value, the valve element 4 is pushed downward, as viewed in FIG. 4, to be lifted. At this time, the refrigerant starts to leak from the whole periphery through a clearance between the valve element 4 and the valve seat 7, and load is applied to the inner peripheral surfaces of the hollow cylindrical protruding portion 14 of the valve element 4.

The hollow cylindrical protruding portion 14 has the windows 15 and 16 formed at circumferentially different intervals, which makes the areas of the surfaces of regions of the portion 14 separated by the windows 15 and 16 circumferentially uneven. Therefore, out of the regions separated by the windows 15 and 16, a circumferentially longer region (region of 210°) has a larger pressure-receiving area than that of a circumferentially shorter region (region of 150°), so that larger transverse load (load in a leftward direction, as viewed in FIG. 4) is generated on the circumferentially longer region, whereby the valve element 4 is caused to perform an axial opening or closing operation while being transversely pressed against the hollow cylindrical valve seat 7. This prevents the valve element 4 from transversely unsteadily moving or wobbling in an inclined state during the opening and closing operations, and therefore when the valve element 4 repeatedly opens to a very small opening degree and closes, it performs the opening and closing operations while sliding on the valve seat 7. This prevents the valve element 4 from being struck against a side surface of the valve seat 7 to thereby suppress generation of noises caused by the striking.

It should be noted that although in the present embodiment, the number of openings (windows 15 and 16) formed in the hollow cylindrical protruding portion 14 of the valve element 4 is set to two, the present invention is by no means limited to this specific embodiment. More specifically, the differential pressure valve according to the present invention is only required to be capable of generating transverse load on the valve element, and hence even when three openings are provided in the hollow cylindrical protruding portion of the valve element as in the conventional differential pressure valve, it is only necessary to prevent the openings from being disposed in a circumferentially uniform arrangement. Therefore, the number of openings may be three or more or one.

Further, also by disposing a spring for pressing the hollow cylindrical protruding portion against the outer periphery of the valve seat, it is possible to obtain the same advantageous effects. For example, if a leaf spring integrally formed with or formed separately from the hollow cylindrical protruding portion is disposed on the inner peripheral surface side of the hollow cylindrical protruding portion, it is possible to generate transverse load on the valve element.

Although in the above-described embodiment, the detailed description has been given of the differential pressure valve used in the clutchless type variable displacement compressor, the present invention can be similarly applied not only to a differential pressure valve for use in an electromagnetic clutch type variable displacement compressor but also to a differential pressure valve provided for being opened at pressure not smaller than a predetermined differential pressure in equipment in other industrial fields.

The differential pressure valve according to the present invention is configured such that load is generated which presses the hollow cylindrical protruding portion of the valve element against the outer peripheral surface of the valve seat, and hence the differential pressure valve opens and closes always in the state in which the valve element slides on the valve seat. This prevents the valve element from striking the valve seat even when the valve repeatedly opens to a very small opening degree and closes, thereby making it possible to largely suppress generation of noise due to the striking, and maintain silence.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A differential pressure valve disposed in a passage communicating with a discharge chamber of a variable displacement compressor, for opening when a difference in pressure between an inlet and an outlet thereof exceeds predetermined pressure, comprising:
an inlet port into which refrigerant from the discharge chamber is introduced;
a hollow cylindrical valve seat extending from a periphery of said inlet port toward a downstream side;
a valve element having a sealing surface moving to and away from an end face of said valve seat, a hollow cylindrical protruding portion extending from an outer periphery of said sealing surface in a manner surrounding said valve seat, and openings formed through said hollow cylindrical protruding portion; and
a spring for urging said valve element in a valve-closing direction,
the differential pressure valve further comprising load-generating means for generating load for pressing said hollow cylindrical protruding portion of said valve element against an outer peripheral surface of said valve seat.

2. The differential pressure valve according to claim 1, wherein said load-generating means is formed by arranging a plurality of the openings at different intervals in a circumferential direction of said hollow cylindrical protruding portion such that said hollow cylindrical protruding portion is pressed against said outer peripheral surface of said valve seat by pressure of refrigerant introduced into said inlet port.

3. The differential pressure valve according to claim 1, wherein said load-generating means is a spring for pressing said hollow cylindrical protruding portion against said outer peripheral surface of said valve seat.

4. The differential pressure valve according to claim 1, further comprising a damper chamber having a hollow cylindrical extending portion protruding from said valve element in an axial direction thereof, and a hollow cylindrical portion formed on a body accommodating said valve element such that one end thereof is closed thereby, for axially movably holding said hollow cylindrical extending portion.
